(19) United States
(12) Patent Application Publication
(10) Pub. No.: US 2026/0126065 A1
(43) Pub. Date: May 7, 2026

(54) Quick Disassembly Device and the Operation Method thereof

(71) Applicant: Nanning FuLian FuGui Precision Industrial Co., Ltd., Nanning (CN)

(72) Inventor: Xiu-Jie LIANG, Nanning (CN)

(21) Appl. No.: 18/947,142

(22) Filed: Nov. 14, 2024

(30) Foreign Application Priority Data
Nov. 1, 2024 (CN) 202411551652.4

(51) Int. Cl. F16B 2/18

(52) U.S. Cl. CPC F16B 2/18

(57) ABSTRACT

A quick disassembly device and the operation method thereof. The quick disassembly device includes a first connection mechanism and a second connection mechanism. The first connection mechanism includes a first housing; a shell movably disposed in the first housing, and including a fastening groove, wherein the fastening groove includes a locking segment, a connection segment, and an unlocking segment; a main elastic element connected to the first housing and a shell. The second connection mechanism includes a second housing; a switch element movably disposed in the second housing, and including a latch; and a transverse elastic element connected to the second housing and the switch element. When the first connection mechanism is connected to the second connection mechanism, the latch is in the locking segment of the fastening groove.

### FIELD

The subject matter herein generally relates to quick disassembly devices and the operation method thereof.

### BACKGROUND

In order to add more functions to products, the products are generally designed in a modular manner. Consumers can replace different modules according to different usage conditions, thereby increasing consumers'willingness to purchase the product. In general, a product with modular design includes a main device and various functional modules. Connection joints are provided on the main device and the functional modules. Consumers can easily replace the functional modules from the main device via the connection joints.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. It will be appreciated that for simplicity and clarity of illustration, where appropriate, reference numerals have been repeated among the different figures to indicate corresponding or analogous elements.

FIG. 1 is a cross-sectional view of a quick disassembly device in accordance with an embodiment of the present disclosure.

FIG. 2 is a perspective view of the electronic apparatus of FIG. 1, wherein a fan device and a handle are in a second position.

FIG. 3, FIG. 4, FIG. 5, and FIG. 6 are operation diagrams of the quick disassembly device corresponding to the operation method of the quick disassembly device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The disclosure is illustrated by way of embodiments and not by way of limitation in the figures of the accompanying drawings, in which like references indicate similar elements. It should be noted that references to “an” or “one” embodiment in this disclosure are not necessarily to the same embodiment, and such references mean “at least one.”

The term “connect” is defined as directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

In the present disclosure, a quick disassembly device is provided and can be applied to a variety of products. The quick disassembly device can easily and quickly assemble and disassemble two parts of the product, thereby improving the convenience of using the product.

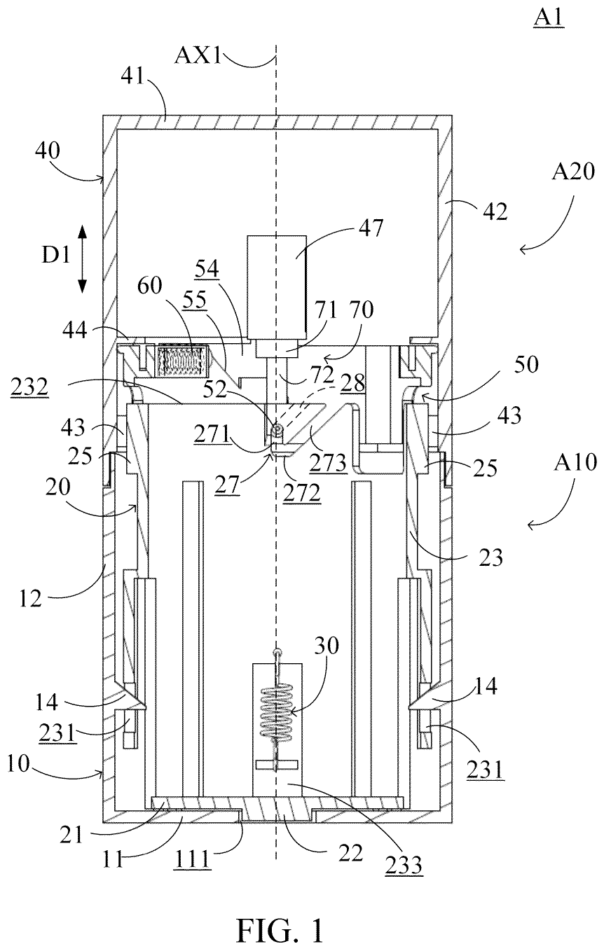

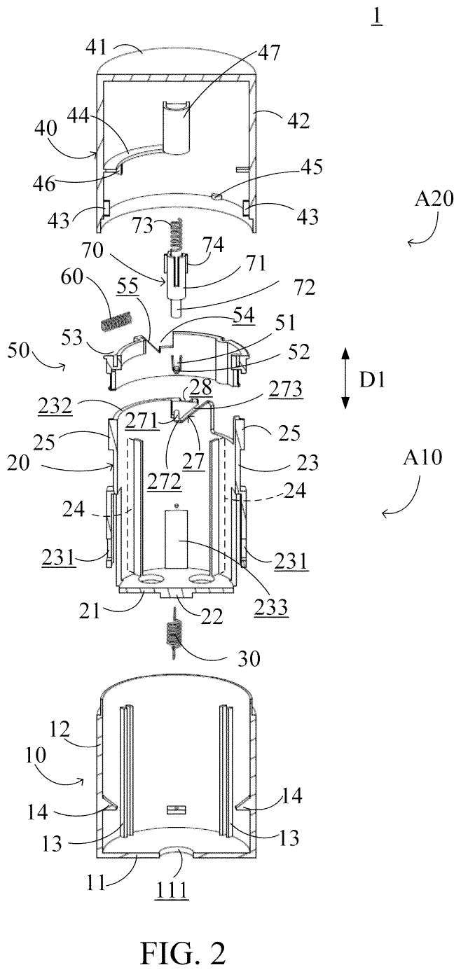

FIG. 1 is a cross-sectional view of a quick disassembly device A1 in accordance with an embodiment of the present disclosure. FIG. 2 is a cross-sectional exploded view of the quick disassembly device A1 shown in FIG. 1. The quick disassembly device A1 includes a first connection mechanism A10 and a second connection mechanism A20. In FIG. 1, the first connection mechanism A10 is connected to the second connection mechanism A20. Moreover, the first connection mechanism A10 and the second connection mechanism A20 are cylindrical structures. However, for the purpose of clarity, a portion of the first connection mechanism A10 and a portion of the second connection mechanism A20 are shown in FIG. 2. The first connection mechanism A10 can be easily assembled with the second connection mechanism A20 without tools, and can be easily separated from the second connection mechanism A20.

The first connection mechanism A10 can be disposed on a first part of a product, and the second connection mechanism A20 can be disposed on a second part of the product. The first part of the product can be assembled with the second part by combining the first connection mechanism A10 with the second connection mechanism A20. For example, the product may be a camera device, a flashlight, a battery box, etc. The first part includes batteries, and the second part includes at least one electronic components, such as a camera, and/or a light source. Therefore, the user can easily replace batteries with the quick disassembly device 1. In some embodiments, the first part of the product may be a rack, and the second part can be an electronic device, such as a camera. The user can easily assemble the electronic device on the rack by the quick disassembly device 1. In some embodiments, the product can be a household product, such as a vacuum cleaner, or a mop. The first part includes a handle, and the second part includes various nozzles or cleaning heads. Therefore, the user can easily replace the nozzle or the cleaning head on the handle.

The first connection mechanism A10 includes a first housing 10, a shell 20, and a main elastic element 30. The first housing 10 may be a hollow columnar structure, extending in a longitudinal direction D1. The first housing 10 can be a housing of the first part of the product, or mounted on the housing of the first part of the product. The first housing 10 includes a bottom plate 11, a first wall 12, first tracks 13, and buckles 14. The bottom plate 11, the first wall 12, the first tracks 13, and buckles 14 may be integrally formed, and can be made of the same materials, such as plastic or metal. The bottom plate 11 may be extends perpendicularly to the longitudinal direction D1. An imaginary axis AX1 extends through the center of the bottom plate 11, and parallel to the longitudinal direction D1. Moreover, the bottom plate 11 may include a bottom opening 111 at the center of the bottom plate 11, and the imaginary axis AX1 may extend through the center of the bottom opening 111. The first wall 12 may be perpendicular to the bottom plate 11, and surround the imaginary axis AX1. The first tracks 13 are disposed on the first wall 12, and extend in the longitudinal direction D1. The buckles 14 are disposed on the first wall 12, and extend toward the imaginary axis AX1.

The shell 20 is movably disposed in the first housing 10. Moreover, the shell 20 may be a hollow columnar structure, extending in the longitudinal direction D1. The shell 20 includes a base plate 21, a pressing bump 22, an inner wall 23, first ribs 24, and second tracks 25. The base plate 21, the pressing bump 22, the inner wall 23, the first ribs 24, and second tracks 25 can be integrally formed, and can be made of the same materials, such as plastic or metal. The base plate 21 extends perpendicular to the longitudinal direction D1, and the imaginary axis AX1 can extend through the center of the bottom plate 11. The pressing bump 22 is at the center of the bottom plate 11, and the imaginary axis AX1 can extends through the center of the pressing bump 22. As shown in FIG. 1, the shell 20 is at an initial position, and the pressing bump 22 is in the bottom opening 111.

The inner wall 23 extends perpendicular to the bottom plate 11, and surrounds the imaginary axis AX1. The inner wall 23 includes slots 231, extending in the longitudinal direction D1. The length of the slot 231 in the longitudinal direction D1 is longer than the length of the buckle 14 in the longitudinal direction D1, and thus the buckle 14 is movably disposed in the slot 231. The buckle 14 and the slot 231 are used to prevent the shell 20 from breaking away from the first housing 10. The first ribs 24 are disposed on the inner wall 23, and extend in the longitudinal direction D1. The first ribs 24 are movably disposed on the first tracks 13, and the first tracks 13 restrict the movement of the first ribs 24 in the longitudinal direction D1. Therefore, the movement of the shell 20 relative to the first housing 10 is restricted in the longitudinal direction D1. The second tracks 25 are disposed on the inner wall 23, and extend in the longitudinal direction D1.

The shell 20 further includes a fastening groove 27 and a sliding groove 28, formed on the inner wall 23. The fastening groove 27 includes a locking segment 271, a connection segment 272, and an unlocking segment 273. The locking segment 271 extends in the longitudinal direction D1, and is separated from the top surface 232 of the inner wall 23. The connection segment 272 may be a curved or elongated shape. The connection segment 272 extends an imaginary plane, which extends perpendicular to the longitudinal direction D1 or the imaginary axis AX1. The locking segment 271 or the longitudinal direction D1 may extend perpendicular to the connection segment 272. The first end of the connection segment 272 is connected to the locking segment 271, and the second end of the connection segment 272 is connected to the unlocking segment 273. The unlocking segment 273 is inclined relative to the locking segment 271 and the connection segment 272, and connected to the top surface 232 of the shell 20. In other words, the unlocking segment 273 of the fastening groove 27 is formed on the top surface 232 of the shell 20, and one end of the unlocking segment 273 of the fastening groove 27 forms an opening on the top surface 232 of the shell 20.

The sliding groove 28 is inclined relative to the longitudinal direction D1. The angle between the sliding groove 28 and the longitudinal direction D1 is smaller than the angle of the unlocking segment 273 and the longitudinal direction D1. The sliding groove 28 includes an inlet end and a blocking end. The inlet end of the sliding groove 28 is connected to the top surface 232 of the shell 20. In other words, the sliding groove 28 is formed on the top surface 232 of the shell 20, and the inlet end of the sliding groove 28 forms an opening on the top surface 232 of the shell 20. The blocking end of the sliding groove 28 is connected to the locking segment 271 of the fastening groove 27.

In the embodiment, the depths of the sliding groove 28 are gradually reduced from the inlet end to the blocking end. The depth of the inlet end of the sliding groove 28 is greater than 2 times the depth of the blocking end of the sliding groove 28. The depths of the sliding groove 28 are measured in different directions, which are perpendicular to the longitudinal direction D1, and extend through the imaginary axis AX1. In the embodiment, the depth of the inlet end of the sliding groove 28 are measured in a first direction, which is perpendicular to the longitudinal direction D1 and extends through the imaginary axis AX1. The depth of the blocking end of the sliding groove 28 is measured in a second direction, which is perpendicular to the longitudinal direction D1 and extends through the imaginary axis AX1.

Two ends of the main elastic element 30 are connected to the first housing 10 and the shell 20. In the embodiment, the inner wall 23 of the shell 20 has a receiving hole 233, and the main elastic element 30 is in the receiving hole 233. One end of the main elastic element 30 is connected to the inner wall 23 of the shell 20, and the other end of the main elastic element 30 is connected to the first wall 12 of the first housing 10. The main elastic element 30 may be a spring. The main elastic element 30 can apply elastic force to the shell 20 and elastically resist against the shell 20 in the longitudinal direction D1, so as to maintain the shell 20 to an initial position relative to the first housing 10. In the drawings of this embodiment, one main elastic element 30 is drawn, but the quick disassembly device A1 may include multiple main elastic elements 30.

The second connection mechanism A20 includes a second housing 40, a switch element 50, a transverse elastic element 60, and a pressing assembly 70. The second housing 40 may be a hollow columnar structure, extending in the longitudinal direction D1. The second housing 40 can be a house of the second part of the product, or mounted on the housing of the second part of the product. The second housing 40 includes a top plate 41, a second wall 42, second ribs 43, top barriers 44, and bottom barriers 45. The top plate 41, the second wall 42, the second ribs 43, the top barriers 44, and the bottom barriers 45 may be integrally formed, and can be made of the same materials, such as plastic or metal. The top plate 41 may extend perpendicular to the longitudinal direction D1, and the imaginary axis AX1 may extend through the center of the top plate 41. The second wall 42 may extend perpendicular to bottom plate 11, and surround the imaginary axis AX1.

The second ribs 43 are disposed on the second wall 42, and extend in the longitudinal direction D1. When the first connection mechanism A10 is connected to the second connection mechanism A20, the second ribs 43 are movably disposed on the second tracks 25 of the shell 20, and the second tracks 25 restrict the movements of the second ribs 43 in the longitudinal direction D1. In other words, the movement of the shell 20 relative to the second housing 40 is restricted in the longitudinal direction D1 by the second ribs 43 and the second tracks 25. The top barriers 44 and the bottom barriers 45 are disposed on the second wall 42 of the second housing 40. The top barriers 44 are parallel to and separated from the bottom barriers 45. The longitudinal direction D1 may be perpendicular to the top barriers 44 and the bottom barriers 45.

The switch element 50 is movably disposed in the second housing 40. In the embodiment, the switch element 50 is movably disposed between the top barriers 44 and the bottom barriers 45. The switch element 50 extends along the second wall 42. An imaginary plane is perpendicular to the longitudinal direction D1, the profiles of the switch element 50 and the second wall 42 on the imaginary plane can be cured profiles. Since the switch element 50 can be curved corresponding to the shape of the second wall 42, the switch element 50 can also rotate relative to the second housing 40. In other words, the switch element 50 can movably or rotatably disposed in the second housing 40.

The switch element 50 include an elastic arm 51 and a latch 52. The latch 52 is connected to the elastic arm 51. As shown in FIG. 1, when the first connection mechanism A10 is connected to the second connection mechanism A20, the latch 52 is located in the locking segment 271 of the fastening groove 27, thereby preventing the first connection mechanism A10 and the second connection mechanism A20 from being separated. When the latch 52 is moved in the sliding groove 28, the elastic arm 51 can apply elastic force to the latch 52 and elastically resist against the latch 52, so that the bottom of latch 52 can continuously contact the bottom of sliding groove 28.

In the embodiment, one elastic arm 51, one latch 52, one sliding groove 28, and one fastening groove 27 are drawn in the drawings of the present disclosure. However, the quick disassembly device A1 may include multiple elastic arms 51, latches 52, sliding grooves 28, and fastening grooves 27.

The transverse elastic element 60 is connected to the second housing 40 and the switch element 50. In the embodiment, the transverse elastic element 60 can be disposed in the receiving groove 53 of the switch element 50. One end of the transverse elastic element 60 abuts the receiving groove 53, and the other end of the transverse elastic element 60 abuts the stopping structure 46 of the second housing 40. The stopping structure 46 is disposed on the second wall 42, and can be connected to the top barrier 44. The transverse elastic element 60 may be spring, and apply elastic force to the switch element 50 and elastically resist against the latch 52. In the embodiment, one transverse elastic element 60 and one stopping structure 46 are drawn in the drawings of the present disclosure. However, the quick disassembly device A1 includes multiple transverse elastic elements 60 and stopping structures 46.

The pressing assembly 70 is disposed on the second housing. When the first connection mechanism A10 is connected to the second connection mechanism A20, the pressing assembly 70 pushes the shell 20. In the embodiment, one pressing assembly 70 is drawn in the drawings of the present disclosure. However, the quick disassembly device A1 may include multiple pressing assemblies 70.

The pressing assembly 70 includes a pressing body 71, an abutting element 72, an upper spring 73, two guiding elements 74, and a pushing element 75 (as shown FIG. 5). The pressing body 71, the abutting element 72, the guiding element 74, and the pushing element 75 are integrally formed, and made of the same materials, such as plastic or metal. The pressing body 71 is movably disposed in the holding base 47 of the second housing 40. The holding base 47 is disposed on the first wall 12 of the housing 10. The abutting element 72 is connected to the bottom of the pressing body 71, and extends in the longitudinal direction D1. The abutting element 72 is used to push the top surface 232 of the shell 20. The pressing body 71 may be a hollow structure, and the upper spring 73 is disposed in the pressing body 71. One end of the upper spring 73 abuts the pressing body 71, and the other end of the upper spring 73 abuts the holding base 47.

The guiding element 74 is disposed on the pressing body 71, and is movably disposed in the holding base 47. The guiding element 74 extends in the longitudinal direction D1, and the movement of the pressing body 71 relative to the holding base 47 is restricted in the longitudinal direction D1. The pushing element 75 in FIG. 5 is disposed on the pressing body 71, and is used to push the inclined surface 55 of the notch 54 of the switch element 50.

In the embodiment, an operation method of the quick disassembly device A1 is provided. The operation method includes a disassembly method and a connection method. As shown in FIG. 1, the first connection mechanism A10 is connected to the second connection mechanism A20, and the first housing 10 contacts the second housing 40. The latch 52 is in the top end of the locking segment 271 of the fastening groove 27. At this time, the side wall of the locking segment 271 blocks the locking segment 271 to move into the sliding groove 28, and the elastic arm 51 in FIG. 2 can apply elastic force to the latch 52, and elastically resist against the latch 52, which can prevent the latch 52 from breaking away from the locking segment 271. The pressing assembly 70 abuts the top surface 232 of the shell 20. The shell 20 is maintained in the initial position by the main elastic element 30. Therefore, the latch 52 can be well maintained in the locking segment 271 through the main elastic element 30 and/or the pressing assembly 70, thereby preventing the first connection mechanism A10 from being separated from the second connection mechanism A20. In addition, since the latch 52 is engaged in the locking segment 271, the switch element 50 can be maintained in the fastening position in FIG. 1

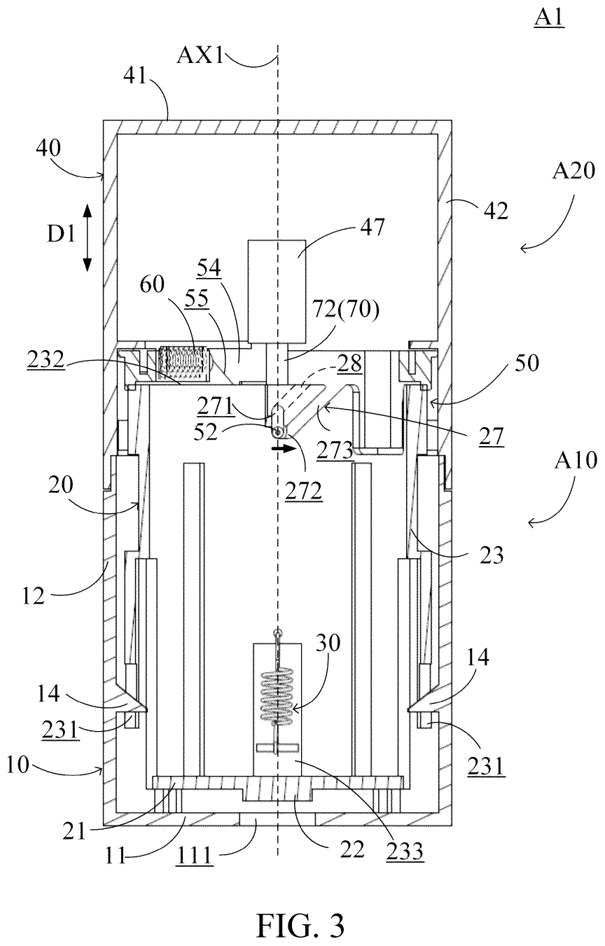

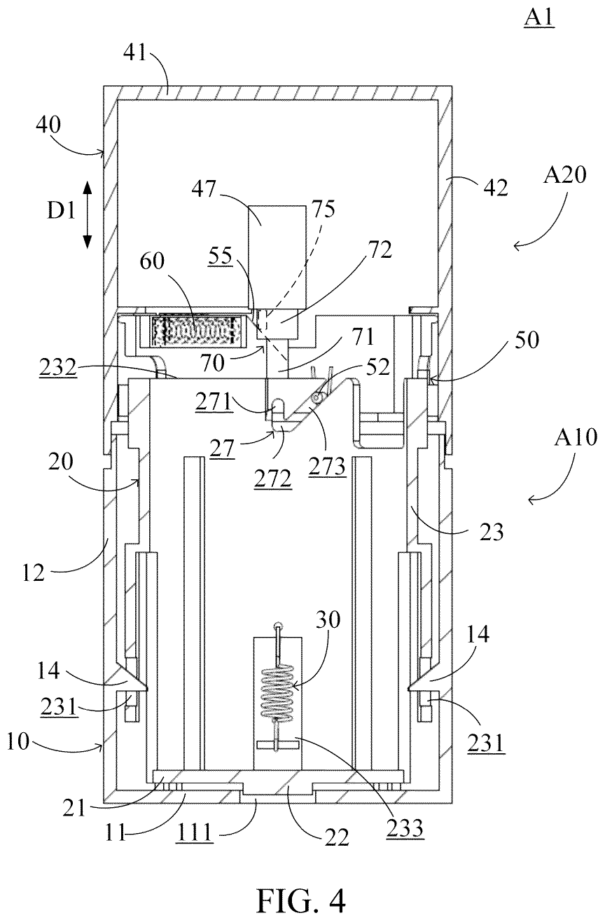

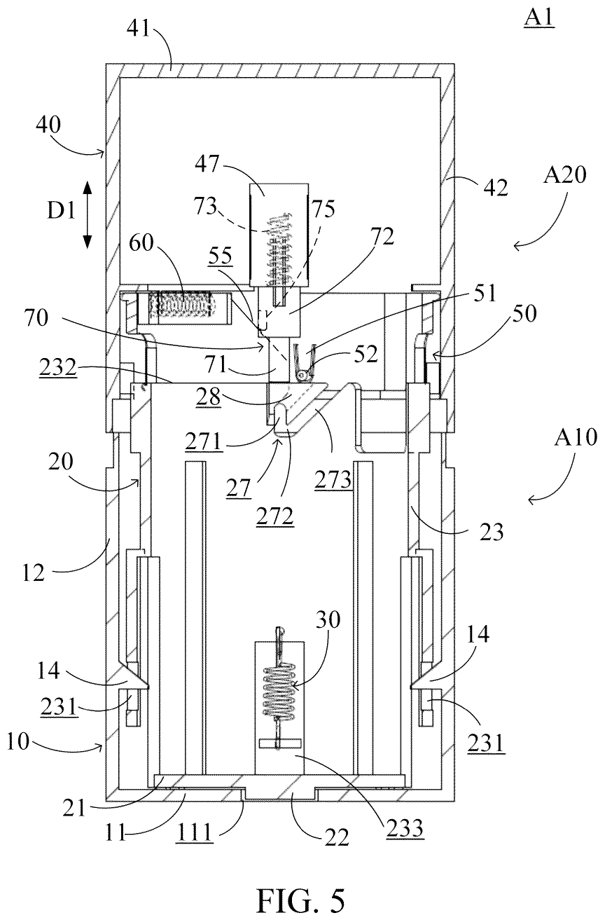

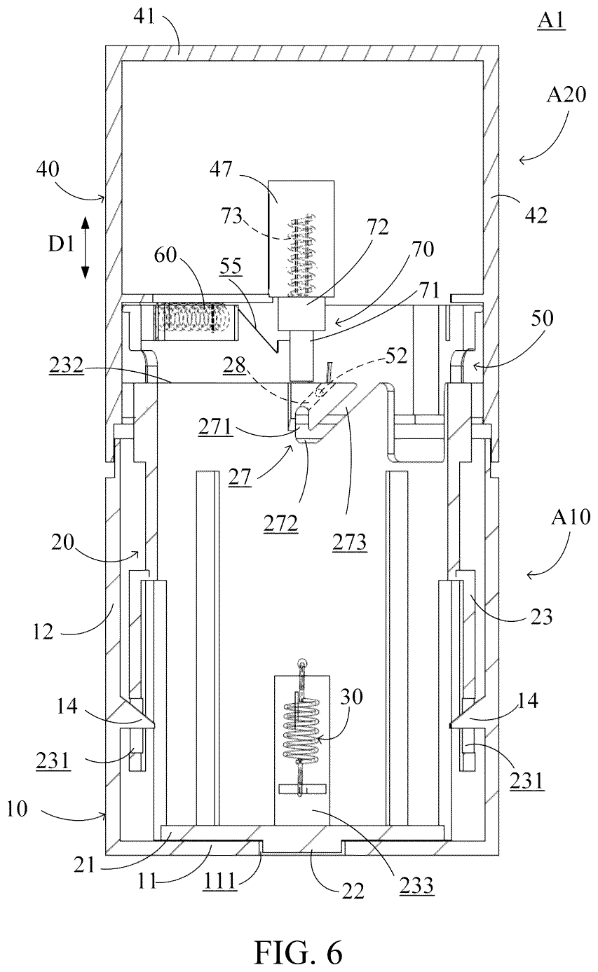

In the first step of the disassembly method, when the first connection mechanism A10 is connected to the second connection mechanism A20, the pressing bump 22 of the shell 20 can be pushed via the bottom opening 111 of the first housing 10, so that the shell 20 is lifted to the unlock position in the longitudinal direction D1 as shown in FIG. 3. Therefore, the latch 52 of the switch element 50 is moved downward from the top end of locking segment 271 of fastening groove 27 to the first end of the connection segment 272 of fastening groove 27.

In the second step of the disassembly method, when the latch 52 is at the first end of the connection segment 272 of the fastening groove 27, the transverse elastic element 60 pushes the switch element 50 toward the right in FIG. 3, so that the latch 52 moves from the first end of the connection segment 272 to the second end of the connection segment 272.

In the third step of the disassembly method, the shell 20 is released as shown in FIG. 4, so that the main elastic element 30 moves the shell 20 downward toward the initial position and the bottom opening 111. Since the shell 20 is moved downward by the main elastic element 30, and the switch element 50 is moved by the transverse elastic element 60, the latch 52 is moved from the second end of the connection segment 272 to the unlocking segment 273 of fastening groove 27 in FIG. 4. In other words, the main elastic element 30 moves the shell 20 in the longitudinal direction D1, and the transverse elastic element 60 moves the switch element 50 in a direction perpendicular to the longitudinal direction D1.

In fourth step of the disassembly method, as shown in FIG. 4, since the latch 52 has entered into the unlocking segment 273, the user can separate the first connection mechanism A10 and the second connection mechanism A20. Afterward, the latch 52 further moves along the unlocking segment 273 toward the top surface 232 of the shell 20, and then breaks away from the unlocking segment 273.

In the fifth step of the disassembly method, the first housing 10 of the first connection mechanism A10 has been separated from the second housing 40 of the second connection mechanism A20. At this time, the pressing assembly 70 pushes the switch element 50 and the latch 52 to move to the preparation position in FIG. 5.

In the embodiment, when latch 52 is located at the top end of the unlocking segment 273 and contacts the top surface 232 of the shell 20, the latch 52 moves the switch element 50 to the right. When the latch 52 is at the top end of the unlocking segment 273 and is above the top surface 232 of the shell 20, the pushing element 75 of the pressing assembly 70 can contact the inclined surface 55. In addition, the transverse elastic element 60 can also move the switch element 50 to the left.

After the first housing 10 has been separated from the second housing 40, and the pressing assembly 70 is separated from the shell 20, the pushing element 75 of the pressing assembly 70 pushes the switch element 50 to move to the left and slides along the inclined surface 55. Afterward, the switch element 50 and the latch 52 are maintained in the preparation position of FIG. 5. In the embodiment, the switch element 50 and the latch 52 can also be moved to or maintained at the preparation position in FIG. 5 by the transverse elastic element 60.

Therefore, the user can easily and quickly separate the first connection mechanism A10 from the second connection mechanism A20 through the quick disassembly device A1 and the disassembly method of the quick disassembly device A1 of this embodiment. In particular, when the user can push the pressing bump 22 through the bottom opening 111 with fingers, the user can easily and quickly assemble the first connection mechanism A10 with the second connection mechanism A20 without tools.

In the step of the connection method, as shown FIG. 5, the switch element 50 and the latch 52 are at preparation position, and the shell 20 is at the initial position. Moreover, the latch 52 has been aligned with the inlet end of sliding groove 28 in FIG. 5. As shown in FIG. 6, the user can move the first housing 10 of the first connection mechanism A10 toward the second housing 40 of the second connection mechanism A20 in the longitudinal direction D1. The latch 52 enters the sliding groove 28 from the inlet end of the sliding groove 28, and move toward the blocking end of the sliding groove 28. Afterwards, the latch 52 can be further moved from the blocking end of the sliding groove 28 to the locking segment 271 of the fastening groove 27 in FIG. 1, thereby assembling the first connection mechanism A10 with the second connection mechanism A20. Therefore, the user can easily align the latch 52 with the inlet end of the sliding groove 28 and move the first connection mechanism A10 toward the second connection mechanism A20, so that the first connection mechanism A10 and the second connection mechanism A20 can be easily and quickly combined without tools.

In conclusion, the quick disassembly device A1 of the present invention can be used in a variety of products that combine two parts. The first connection mechanism can be easily and quickly assembled with the second connection mechanism without tools, and can be easily and quickly separated from the second connection mechanism.

Many details are often found in the relevant art, thus many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will, therefore, be appreciated that the embodiments described above may be modified within the scope of the claims.

What is claimed is:

1. A quick disassembly device comprising:
a first connection mechanism comprising:
a first housing;
a shell movably disposed on the first housing, and comprising a fastening groove, wherein the fastening groove comprises a locking segment, a connection segment, and an unlocking segment;
a main elastic element connected to the first housing and the shell; and
a second connection mechanism comprising:
a second housing;
a switch element movably disposed in the second housing, and comprising a latch; and
a transverse elastic element connected to the second housing and the switch element,
wherein when the first connection mechanism is connected to the second connection mechanism, the first housing contacts the second housing, the shell is at an initial position, and the latch is in the the locking segment of the fastening groove,
as the first connection mechanism separating from the second connection mechanism, the shell is moved to an unlock position, so that the latch moves from the locking segment to the connection segment, the transverse elastic element moves the switch element, and
after the shell is released, the main elastic element moves the shell toward the initial position, and the latch is moved to the unlocking segment.

2. The quick disassembly device as claimed in claim 1, further comprising a pressing assembly disposed on the second housing,
wherein the pressing assembly pushes the shell when the first connection mechanism is connected to the second connection mechanism.

3. The quick disassembly device as claimed in claim 2, wherein the switch element further comprises a notch, the notch comprises an inclined surface, and
the pressing assembly pushes the inclined surface to maintain the switch element at a preparation position after the first connection mechanism is separated from the second connection mechanism.

4. The quick disassembly device as claimed in claim 2, wherein the first housing comprises a holding base, and the pressing assembly comprises:
a pressing body movably disposed in the holding base;
an abutting element connected to the pressing body; and
an upper spring abutting the second housing and the holding base.

5. The quick disassembly device as claimed in claim 1, wherein the shell further comprises a sliding groove, an inlet end of the sliding groove is connected to a top surface of the shell, a blocking end of the sliding groove is connected to the locking segment, and
the latch is moved into the locking segment via the sliding groove during assembling the first connection mechanism with the second connection mechanism.

6. The quick disassembly device as claimed in claim 1, wherein the switch element further comprises an elastic arm connected to the latch.

7. The quick disassembly device as claimed in claim 1, wherein the first housing comprises a bottom opening, and the shell comprises a pressing bump, and the pressing bump is in the bottom opening when the shell is at the initial position.

8. The quick disassembly device as claimed in claim 1, wherein the first housing comprises a first track, the shell further comprises a first rib, the first rib is movably disposed on the first track, and the first track restricts the first rib moving in a longitudinal direction.

9. The quick disassembly device as claimed in claim 1, wherein the shell further comprises a second track, the second housing comprises a second rib, the second rib is movably disposed on the second track, and
the second track restricts the second rib moving in a longitudinal direction when the first connection mechanism is connected to the second connection mechanism.

10. The quick disassembly device as claimed in claim 1, wherein the first housing comprises a buckle, the shell further comprises a slot, the buckle is movably disposed in the slot, and the buckle and the slot prevent the shell from breaking away from the first housing.

11. The quick disassembly device as claimed in claim 1, wherein the second housing comprises a top barrier and a bottom barrier parallel to the top barrier, and the switch element is movably disposed between the top barrier and the bottom barrier.

12. The quick disassembly device as claimed in claim 1, wherein the switch element further comprises a receiving groove, and the transverse elastic element is disposed in the receiving groove.

13. The quick disassembly device as claimed in claim 1, wherein the locking segment extends in a longitudinal direction, and extends perpendicularly to the connection segment, and the unlocking segment is inclined relative to the locking segment and the connection segment, and connected to a top surface of the shell.

14. An operation method of a quick disassembly device comprising:
pushing a shell in a first housing of a first connection mechanism so that a latch of a switch element in a second housing of a second connection mechanism moves from a locking segment of a fastening groove of the shell to a first end of a connection segment of the fastening groove;
moving the switch element by a transverse elastic element of the second connection mechanism, so that the latch moves from a first end of the connection segment to a second end of the connection segment;
releasing the shell, so that a main elastic element of the first connection mechanism moves the shell toward an initial position, and the latch is moved from the second end of the connection segment to an unlocking segment of the fastening groove; and
separating the first connection mechanism from the second connection mechanism, so that the latch is separated from the unlocking segment.

15. The operation method as claimed in claim 1, further comprising pushing the switch element to a preparation position by a pressing assembly disposed in the second housing.
